(19) United States
(12) Patent Application Publication
(10) Pub. No.: US 2023/0311287 A1
(43) Pub. Date: Oct. 5, 2023

(54) MULTIFUNCTIONAL HAMMER

(71) Applicant: VANDERBILT UNIVERSITY, Nashville, TN (US)

(72) Inventor: Kevin C. Galloway, Nashville, TN (US)

(21) Appl. No.: 18/044,125

(22) PCT Filed: Oct. 22, 2021
(86) PCT No.: PCT/US2021/056192

§ 371 Date: Mar. 6, 2023

Related U.S. Application Data
(60) Provisional application No. 63/104,793, filed on Oct. 23, 2020.
(60) Provisional application No. 63/183,973, filed on May 4, 2021.

(51) Int. Cl. B25D 1/04; B25G 1/10

(52) U.S. Cl. CPC B25D 1/045; B25G 1/10

(57) ABSTRACT

Various embodiments of a multifunctional hammer for driving tent stakes into the ground and removing stakes from the ground is described. In one example, a head for a multifunctional hammer can include an impact portion, an extraction portion, and a central portion therebetween. The impact portion and the central portion form a main body of the head. The extraction portion flaring outward from the main body and tapering in thickness and branching with two claws from a base to a forked tip end forming an opening configured to receive a stake head. The opening of the extraction portion being substantially symmetrical having first width at the forked tip end tapering inwardly to opposed edges having a second width and forming a seat at the base of the two claws. In another example, a multifunctional hammer can include the head for a multifunctional hammer and a handle attached to the head.

### CROSS-REFERENCE TO RELATED APPLICATIONS

This application claims the benefit of and priority to U.S. Provisional Application Ser. No. 63/104,793, filed on Oct. 23, 2020, and U.S. Provisional Application Ser. No. 63/183,973, filed on May 4, 2021, the entire contents of both of which are hereby incorporated by reference.

### BACKGROUND

A variety of stakes are available to secure a tent, netting, or other flexible structure to the ground. A stake typically has a tapered end that is driven into the ground by applying a force to the head at the other end of the stake. The head of the stake can have extensions, hooks, or wings to secure a rope of a tent or netting. Stakes driven into to the ground can be very difficult to manually pull out especially if the ground is dry or frozen.

### SUMMARY

A multifunctional hammer is described. In one example, a head for a multifunctional hammer can include an impact portion, an extraction portion, and a central portion therebetween. The impact portion and the central portion form a main body of the head. The extraction portion flaring outward from the main body and tapering in thickness and branching with two claws from a base to a forked tip end forming an opening. The impact portion of the head having a face end opposite the forked tip end. The head having a top surface extending from the face end to the forked tip end. The main body having two cheek surfaces extending downward from the top surface to a bottom surface. The opening of the extraction portion is configured to receive a stake head. The opening of the extraction portion being substantially symmetrical having first width at the forked tip end tapering inwardly to opposed edges having a second width and forming a seat at the base of the two claws.

In additional aspects, the top surface of the head for multifunctional hammer can have a curved shape extending from the main body to the forked tip end. The top surface can be configured to facilitate extraction of a stake. The extraction portion further can include an extraction bottom surface extending from a back surface of the main body to the forked tip end. The bottom surface can be configured to facilitate extraction of a stake. The opening of the extraction portion can be configured to receive a stake head. The opening of the extraction portion further can include a contoured section extending inwardly from the opposed edges. The extraction portion further can include a stake protrusion seat in the extraction bottom surface of the extraction portion. The stake protrusion seat formed by a rounded indentation across both claws and the width of the extraction portion near the back surface of the main body. The extraction portion further can include a tapered collar in the extraction bottom surface of the extraction claw portion surrounding the half pipe cavity and extending to each of the two claws within the stake protrusion seat. The contoured section may include a third width and a half pipe cavity within the opening, where the opening tapers inward from the second width to the third width and the half pipe cavity forms the seat in the opening of the claw. The head can weigh between about 2 and about 8 pounds.

In some cases, the top surface of the main body of the head for the multifunctional hammer further includes a concave indentation extending from the face end and having a curved perimeter. The concave indentation can be configured to receive a boot tip to act as a fulcrum for stake extraction. In some cases, the top surface of the main body further includes a linear indentation between the face end and the central portion. The linear indentation being substantially parallel to the face end and configured to receive as least a portion of a block to act as a fulcrum for stake extraction.

In additional aspects, the head for multifunctional hammer can include one or more markers on the extraction bottom surface configured to facilitate positioning of the opening of the extraction portion with respect to the stake to be extracted. The one or more markers can be applied using a marker material detectable in visible light, non-visible light, or both. The head for multifunctional hammer can include one or more markers configured to facilitate positioning of the hammer face for hammering a stake.

In additional aspects, the extraction portion of the head for the multifunctional hammer can be detachably attached to the main body. The extraction portion further can include a base surface and a keyed protrusion extending from the base surface and the main body can have a keyed groove configured to receive the keyed protrusion of the extraction portion. The extraction portion can be secured to the main body via one or more fasteners.

In another example, a multifunctional hammer can include the head and a handle having a proximal end and a distal end, the handle attached to the head. In some cases, the main body of the head can include an aperture through the central portion of the head, the aperture extending from top surface to the bottom surface, and where the proximal end of the handle is secured in the aperture of the head. The head and the handle are fabricated in one piece. The handle has a length of about 12 to about 18 inches. The multifunctional hammer may include an overstrike protector attached to the handle at a portion abutting the base of the head.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1A illustrates an example of an isometric view of the multifunctional hammer from the hammer face angle according to various embodiments described herein.

FIG. 1B illustrates an example of an isometric view of the multifunctional hammer from the claw angle according to various embodiments described herein.

FIG. 1C illustrates an example of a side view of the multifunctional hammer according to various embodiments described herein.

FIG. 1D illustrates an example of a top view of the multifunctional hammer according to various embodiments described herein.

FIG. 2 illustrates an example of a side view of the multifunctional hammer shown in FIGS. 1A-1D engaged with a stake for removal from the ground according to various embodiments described herein.

FIGS. 3A-3E illustrate multiple views of an example multifunctional hammer configured to extract tent stakes with a small branch or protrusions according to various embodiments described herein.

FIG. 4 illustrates an example of tent pin stake with a small branch according to various embodiments described herein.

FIGS. 5A and 5B illustrate views of the tent pin stake engaged with the multifunctional hammer of FIG. 3A according to various embodiments described herein.

FIGS. 6A and 6B illustrates examples of the multifunctional hammer of FIG. 3A positioned to extract two different types of stakes according to various embodiments described herein.

FIGS. 7A and 7B illustrate side and front views of an example multifunctional hammer with a concave indentation on the top of the hammer according to various embodiments described herein.

FIG. 8 illustrates an example of a side view of the operation of the multifunctional hammer with a concave indentation shown in FIGS. 7A and 7B adapted to the curvature of the toe of a boot according to various embodiments described herein.

FIG. 9A and 9B illustrate side and front views of an example multifunctional hammer with an indentation on the top of the hammer according to various embodiments described herein.

FIG. 10 illustrates an example of a side view of the operation of the multifunctional hammer with the indentation shown in FIGS. 9A and 9B engaged with a block according to various embodiments described herein.

FIG. 11 illustrates an isometric view of an example multifunctional hammer with at least one marker according to various embodiments described herein.

FIG. 12 illustrates an isometric view of an example multifunctional hammer with at least one magnet according to various embodiments described herein

FIG. 13 illustrates an example of an isometric view of a multifunctional hammer with an overstrike protector according to various embodiments described herein

FIG. 14 presents an isometric view of an example multifunctional hammer having a detachable extraction claw portion according to various embodiments described herein

FIG. 15A illustrates an example of an isometric view of a detachable claw according to various embodiments described herein.

FIG. 15B illustrates an example of an isometric view of the detachable claw connected to a hammer according to various embodiments described herein.

### DETAILED DESCRIPTION

Described below are various embodiments of the present multifunctional hammer. Although particular embodiments are described, those embodiments are mere exemplary implementations of the multifunctional hammer. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise defined, used or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2%) can be understood as being within the scope of the description; likewise, if a particular shape is referenced, the shape is intended to include imperfect variations from ideal shapes, e.g., due to manufacturing tolerances. Percentages or concentrations expressed herein can represent either by weight or by volume.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

In the context discussed above, tents, netting, or other flexible structures can be secured to the ground with stakes, also called tent stakes herein. The structures or covers to be secured can be provided with loops, apertures, grommets, netting, and the like for the stakes to be inserted. In some examples, the stakes are secured in another manner. A stake typically has a tapered end that is driven into the ground using a standard mallet to apply a force to the head at the other end of the stake. The head of the stake can have extensions, hooks, or wings to secure a rope of a tent or netting. Stakes driven into to the ground can be very difficult to manually pull out especially if the ground is dry or frozen. As some structures are erected on a temporary basis, there is a need for a tool to quickly and efficiently pull out stakes.

The present disclosure relates to a multifunctional hammer can be used to both drive tent stakes into the ground and, with the same tool, quickly and efficiently pull stakes out of the ground. Stakes driven into to the ground to hold a tent in place or stabilize a structure can be very difficult to manually pull out, especially if the ground is dry or frozen. The multifunctional hammer addresses three problems with the process of removing stakes: damage to equipment, wasted physical energy, and tool overhead.

To manually pull a stake out of the ground, an operator may laterally hit the top of the stake to loosen it in the ground, pull on it and repeat this process until the stake is removed. However, laterally hitting the top of the stake may damage it. Another method is to pull on the tent material, rope, or webbing material attached to the stake. However, pulling on the material in this manner can abrade the material faster and reduce its useful life. Pulling on the tent material is also physically exhausting and creates opportunities for poor biomechanical posture, such as leaning over, which increases the risk of injury to the operator. Lastly, when operating in austere environments, it is important to minimize equipment overhead, such as the number of tools that need to be maintained, tracked, transported and stored. In this scenario, multifunctional tools are preferred over single function tools.

The multifunctional hammer disclosed herein can overcome the aforementioned disadvantages. A multifunctional hammer provides a single tool for hammering stakes into the ground and extracting them. In particular, a claw is provided, which is configured to hook under the heads of a variety of tent stakes for rapid stake extraction. When the claw engages protrusions near the head of the stake the operator benefits from a large mechanical advantage (greater than 5:1) to extract the stake by pulling on the handle. This reduces physical effort for the operator, reduces time to remove stakes, minimizes damage to the netting or tent (i.e. operator doesn't have to pull on it), and is provided in a form that can replace the single use hammer or mallet with the multifunctional hammer without taking up extra room.

In the following discussion, a general description of the multifunctional hammer is provided, followed by a discussion of the method of operation of the same. A non-limiting example of multifunctional hammer configured to drive tent stakes into the ground, and with the same tool, to quickly and efficiently pull stakes out of the ground and that overcomes such disadvantages is discussed.

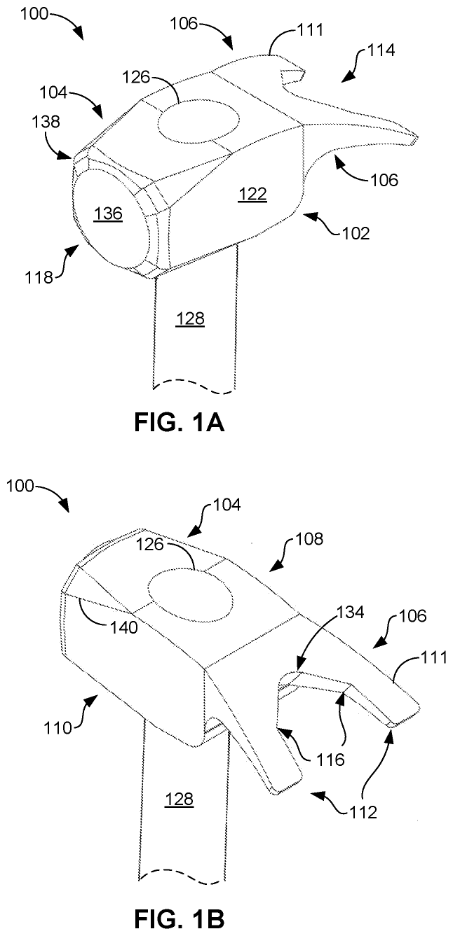

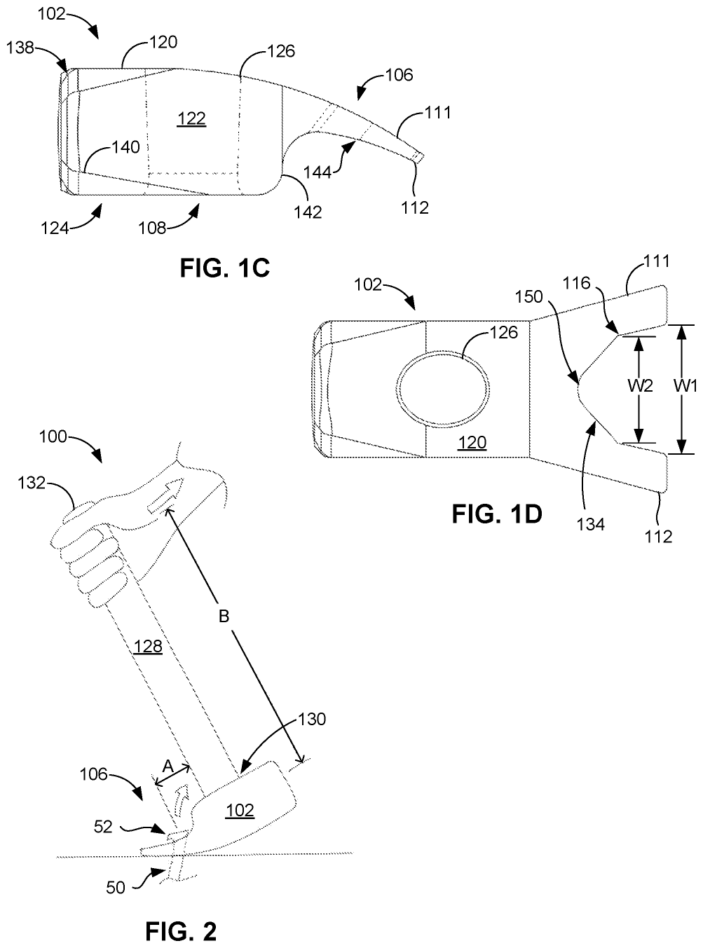

Turning to the drawings, FIGS. 1A-1D illustrate an example of multifunctional hammer 100. The multifunctional hammer 100 can include a head 102 comprising an impact portion 104, an extraction claw portion 106, and a central portion 108 therebetween. The impact portion 104 and the central portion 108 can form a main body 110 of the head 102. The extraction claw portion 106 flaring outward from the main body 110 and tapering in thickness and branching with two claws 111 from a base to a forked tip end 112 forming a claw opening 114. The impact portion 104 of the head 102 can have a face end 118 opposite the forked tip end 112. The head 102 can have a top surface 120 extending from the face end 118 to the forked tip end 112. The main body 110 can have two cheek surfaces 122, on opposing sides, extending downward from the top surface 120 to a bottom surface 124. In some examples, the main body 110 can have an aperture 126 through the central portion 108 extending from the top surface 120 to the bottom surface 124. A handle 128 can be secured in the aperture 126 of the head 102. In some examples, the head 102 and handle 128 can be formed in one-piece.

The face end 118 of the impact portion 104 the multifunctional hammer 100 can comprise a striking face 136. In some examples, the striking face 136 can be substantially planar. In some examples, the striking face can be convex with a maximum convexity of 250 mm radius through the central longitudinal axis. The striking face is usable for pounding on objects such as tent stakes 50 into the ground (not shown). In some examples, the face end 118 can further include a transitional edge 138 that extends from the striking face 136 to the top surface 120, the bottom surface 124, and the cheek surfaces 122. The transitional edge 138 can have a smooth contour, a chamfered edge, or include a plurality of bevels. The main body 110 can also include transition sections 140 forming additional surfaces and a more gradual transition between the striking face 136 to the top surface 120, the bottom surface 124, and the cheek surfaces 122.

The main body 110 can include a back surface 142 opposite the face end 118. In an example, the back surface 142 provides a transition from the bottom surface 124 of the main body 110 to an extraction bottom surface 144 of the extraction claw portion 106, as shown in FIG. 1C. In some examples, the top surface 120 of the multifunctional hammer 100 can have curved shape configured to facilitate extraction of a stake 50 by the stake head 52 (FIG. 2). For example, a portion of the top surface 120 can have a radius of curvature of about 3 inches or greater. For example, a portion of the top surface 120 can have a radius of curvature can be between about 6.0 and 7.5 inches. For example, a portion of the top surface 120 can have a radius of curvature of about 6.75 inches. In some examples, the top surface 120 can be a substantially flat surface. The extraction bottom surface 144 can have a curvature different that the top surface 120. In some examples, the extraction claw portion 106 is not a fully curved claw and at least a portion of the top surface 120 and/or at least a portion of the bottom surface 144 of the claws 111 is substantially flat. The claw opening 114 of the extraction claw portion 106 is configured to receive a stake 50, just below the stake head 52, such that the stake head 52 rests or is seated upon the bottom surface 144 of the extraction claw portion 106. In some embodiments, the claw opening 114 can correspond to a stake head of a specific stake.

As shown in FIG. 1D, the claw opening 114 at a portion between the claws 111 of the extraction claw portion 106 can be substantially v-shaped having a contoured section 134 at the base where the forked portions of the claws 111 begin to separate tapering to the forked tip end 112. The claw opening 114 of the extraction claw portion 106 can be substantially symmetrical having first width W1 at the forked tip end 112 tapering inwardly to opposed edges 116 having a second width W2 and forming a seat 150 at the base of the two claws 111. The portion of the claw opening 114 between the forked tip end 112 and opposed edges 116 can be considered a seat guide. The claw opening 114 of the extraction claw portion 106 can be configured accommodate a range of different stakes. The claw opening 114 of the extraction claw portion 106 can further comprise a contoured section 134 extending inwardly from the opposed edges 116. In some examples, the contoured section 134 simply provides a smooth transition between the forked portions of the extraction claw portion 106, as shown in FIGS. 1A-1D. In some examples, the contoured section 134 can be configured to receive a specified stake.

For example, some military units use tent stakes (e.g. MIL-P-501) which can be formed from a plate to have a substantially consistent thickness for stacking multiple stake in storage and with a v-shaped cross-section for strength. The stake can have a length of about 12 inches. The stake head of the can be formed with protrusions to allow a better grip to remove the stake from the ground. The stake head also provides a surface to strike when installing the stakes. The extraction claw portion 106 of the multifunctional hammer 100, shown in FIGS. 1A-1D, can receive a stake with a v-shaped cross-section. The multifunctional hammer 100 can also be relied on for other types of stakes, such as guy wire stakes, v-cross section type stakes, tent pin stakes, and the like.

The weight of the head 102 of the multifunctional hammer 100 can range from about 2 to about 8 pounds. In some examples, the multifunctional hammer 100 can be considered a 3 pound. hammer. In some examples, the length of the handle 128 can range from about 12 to about 18 inches. In some examples, the length of the handle 128 can be about 36 inches or less. The extraction claw portion 106 with the claw opening 114 can be configured to adapt to the heads of most stakes and gives the operator a roughly 10:1 mechanical advantage to quickly extract stakes with less effort. The mechanical advantage can vary and is based on the length of the handle 128 and the position of a stake being extracted relative to the handle.

As shown in FIG. 2, the claw opening 114 is wider at the forked tip end 112 and then narrows to enable the operator to hook under the protrusions of a stake 50 without significant precision. The handle 128 of the multifunctional hammer 100 can have a proximal end 130 and a distal end 132. The proximal end 130 can be secured in the aperture 126 of the head 102. Once the claw opening 114 hooks under protrusions 54 on the stake head 52, the operator can pull on the distal end 132 of the handle 128 to generate a large mechanical advantage, which is defined at length B over length A (B:A). As shown in FIG. 2, length A is drawn from the position of the stake seated in the claw opening to the hammer handle and length B is the central axis of the hammer head to about the position of the operator's hand on the handle. A mechanical advantage of 5:1 or more is preferred. For example, an operator pulling with 10 lbs. of force can generate up to 50 lbs. of extraction force. It should be noted that the handle 128 may be made out of wood, metal, or composite material or any material that can handle larger stresses. The handle 128 can also be glued, screwed, wedged, or welded to the hammer head. The head 102 and handle 128 can also be formed in one piece or fabricated as one monolithic part, preferably metal. For example, the head 102 and handle 128 can be cast in the same metal. For example, the metal can be a steel or steel alloy, such as 4140 steel.

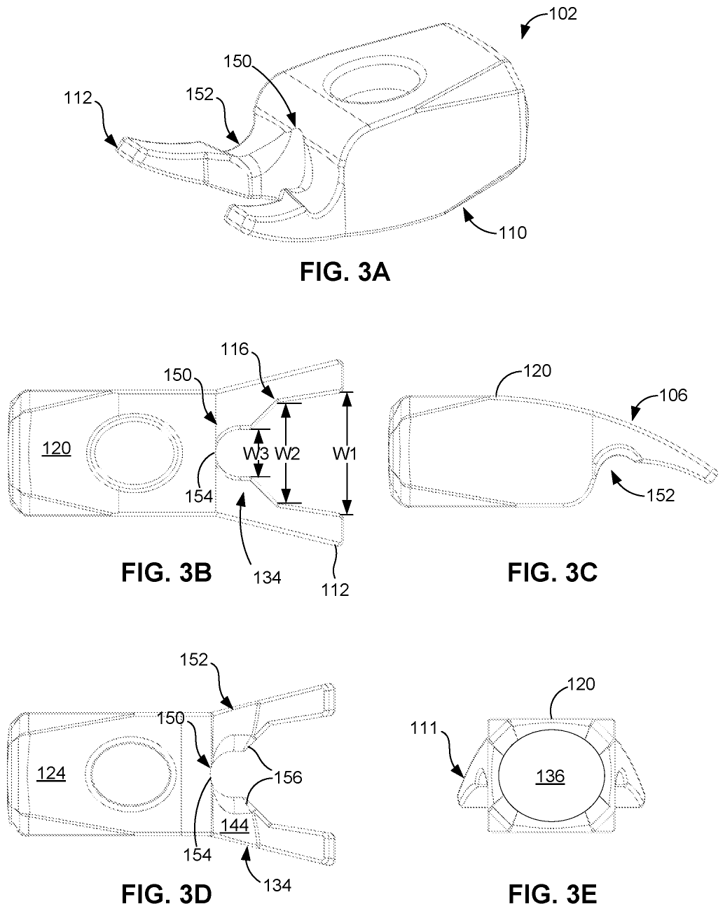

In another example, as shown in FIGS. 3A-3E, the head 102 of the multifunctional hammer 100 can be configured with additional contours and/or seats formed in the extraction claw portion 106 to accommodate a wide range of stakes. In this example, the multifunctional hammer 100 is substantially the same as the multifunctional hammer 100 of FIGS. 1A-1D. As shown in FIGS. 3A-3E, the head 102 of multifunctional hammer 100 can include an impact portion 104, an extraction claw portion 106, and a central portion 108 therebetween. The impact portion 104 and the central portion 108 can form a main body 110 of the head 102. The extraction claw portion 106 flaring outward from the main body 110 and tapering in thickness and branching with two claws 111 from a base to a forked tip end 112 forming a claw opening 114. The impact portion 104 of the head 102 can have a face end 118 opposite the forked tip end 112. The head 102 can have a top surface 120 extending from the face end 118 to the forked tip end 112. The main body 110 can have two cheek surfaces 122, on opposing sides, extending downward from the top surface 120 to a bottom surface 124. The main body 110 can have an aperture 126 through the central portion 108 extending from the top surface 120 to the bottom surface 124. A handle 128 can be secured in the aperture 126 of the head 102.

As shown in FIGS. 3A-3E, the extraction claw portion 106 is configured with additional contours and/or seats. In this example, there is a stake protrusion seat 152 in the extraction bottom surface 144 of the extraction claw portion 106. The stake protrusion seat 152 can be formed by a rounded indentation across both claws 111 and the width of the extraction claw portion 106 near the back surface 142 of the main body 110 in the extraction bottom surface 144. As shown, the claw opening 114 can extend to or near the back surface 142 of the main body 110.

In this example, the contour section 134 can include a half-pipe cavity 154 to form seat 150. As shown in FIG. 3B, the claw opening 114 at a portion between the claws 111 of the extraction claw portion 106 can have a contoured section 134 at the base where the forked portions of the claws 111 begin to separate tapering to the forked tip end 112. The claw opening 114 of the extraction claw portion 106 can be substantially symmetrical having first width W1 at the forked tip end 112 tapering inwardly to opposed edges 116 having a second width W2 between the two claws 111. The contoured section 134 between opposed edges 116 and seat 150 can include a third width W3. A half-pipe cavity 154 can be configured as the seat 150 at the base of the forked claws 111.

The portion of the claw opening 114 between the forked tip end 112 and opposed edges 116 can be considered a seat guide. The claw opening 114 of the extraction claw portion 106 can be configured accommodate a range of different stakes. The claw opening 114 of the extraction claw portion 106 can further comprise a contoured section 134 extending inwardly from the opposed edges 116. In some examples, the contoured section 134 simply provides a smooth transition between the forked portions of the extraction claw portion 106, as shown in FIGS. 1A-1D. In some examples, the contoured section 134 can be configured to receive a specified stake. As shown in FIG. 3D, the extraction bottom surface 144 of the extraction claw portion 106 can also include a tapered collar portion 156 extending to each of the two claws 111 within the stake protrusion seat 152.

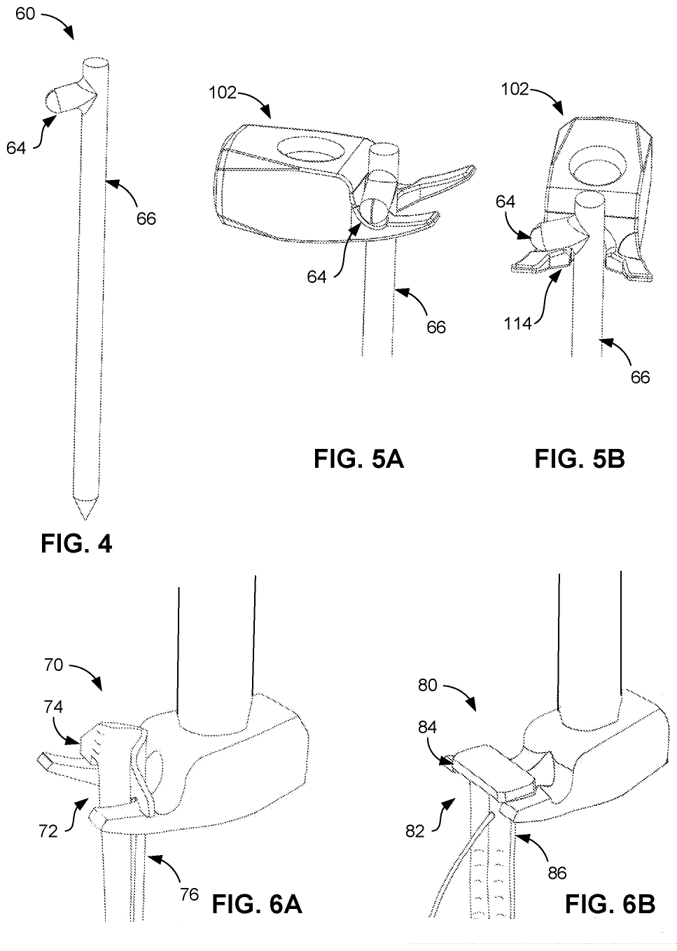

For example, the multifunctional hammer 100 can be configured to extract tent stakes, such as a tent pin stake 60 shown in FIG. 4, having a small steel branch protrusion 64. In this example, the multifunctional hammer 100 addresses a challenge to extract tent pin stakes 60 which have a steel rod main body 66 with a small steel branch 64 that protrudes out at an angle. This example multifunctional hammer 100 having the stake protrusion seat 152, a half-pipe cavity 154, and tapered collar portion 156 in at the base of the extraction claw portion 106 such that the claw opening 114 adapts to stake body 66 of the tent pin stake 60. This feature allows an operator to hook the claw portion 106 of the multifunctional hammer 100 under the steel branch 64 to rest in at least one side of the stake protrusion seat 152. With the steel branch 64 seated in the stake protrusion seat 152, the tent pin stake 60 does not twist about the long axis of the main body 66 and twist out of the claw portion 106 of the multifunctional hammer 100. This also prevents an awkward torque to the hammer handle 128 (and hence to the operator) that would require multiple attempts to retrieve this type of stake. Furthermore, stake protrusion seat 152 at the base of the extraction claw portion 106 at the claw opening 114 can incorporate a collar 154 at the half pipe cavity for the tent pin stake branch 54 to rest which significantly impedes the ability of the tent pin stake 50 to twist. Additionally, the indentations of the stake protrusion seat 152 enable the operator to hook under the small steel branch 64 from inside the claw opening 114, resting on the stake protrusion seat 152 of either claw 111, or outside the claw on either side. As shown in FIGS. 4A-6, this example multifunctional hammer enables the operator to extract three common types of stakes (e.g. guy wire stake, v-cross section type stakes, and tent pin stakes) used to anchor camo netting, tents, and other temporary structures.

Shown in FIG. 4 is a tent pin stake 60 with a steel rod body 66 and a stake head 62 comprising a small steel branch 64. Shown in FIGS. 5A and 5B are two views of the multifunctional hammer 100 with the tent pin stake 60 engaged inside claw 106 with steel branch 64 of stake resting in the stake protrusion seat 152 on one side of the claw, thus reducing the tendency the stake to twist out of the curved claw 106 to during extraction.

FIGS. 6A and 6B illustrate two examples of the multifunctional hammer of FIG. 3A positioned to extract stakes. Shown in FIG. 6A is an example of the head portion 72 of a v-cross section type stake 70, such as a MIL-P-50 stake, seated in the claw portion 106 of the multifunctional hammer 100. In some examples, the protrusions 74 of the v-cross section type stake 70 can rest in the stake protrusion seat 152. In some examples, the protrusions 74 of the v-cross section type stake 70 can rest on the bottom surface 144 of the claws 111. Similarly, shown in FIG. 6B is an example of the head portion 82 of guy wire stake 80 seated in the claw portion 106 of the multifunctional hammer 100. In some examples, the protrusions 84 of the guy wire stake 70 can rest on the bottom surface 144 of the claws 111.

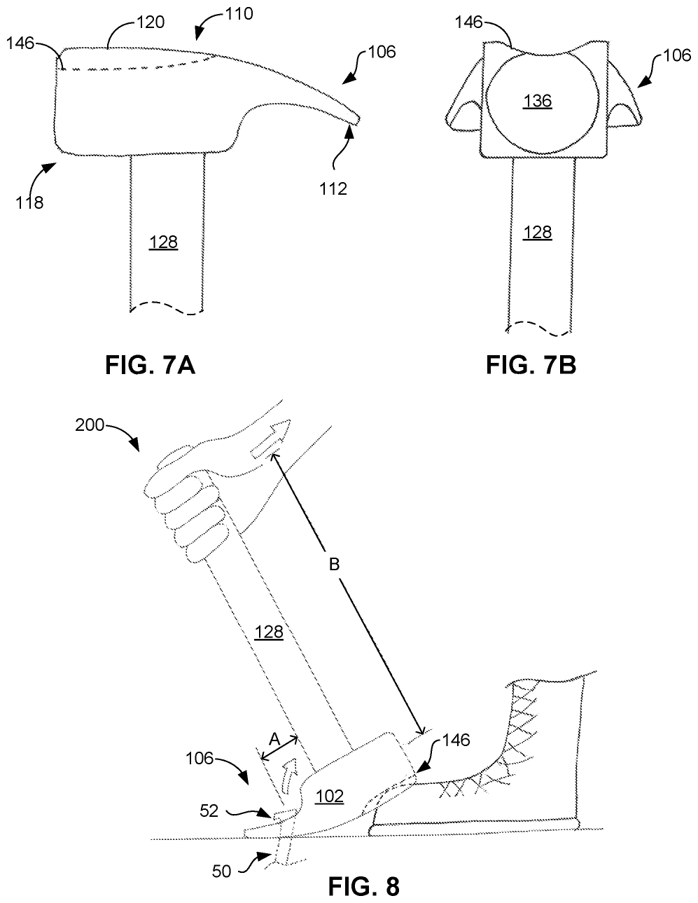

FIGS. 7A and 7B illustrates a side and top view of another example of the multifunctional hammer 100 with a concave indentation 146 along the top surface 120 of the main body 110 extending from the face end 118 and having a curved perimeter. For example, the concave indentation 146 can extend from the face end 118 to a portion of the central portion 106. For example, the concave indentation 146 can be configured to receive a boot tip to act as a fulcrum for stake extraction. The concave indentation 146 can be a feature of the multifunctional hammer 100 shown in any of the embodiments disclosed herein.

As shown in FIG. 8, the concave indentation 146 can partially match the curvature of the toe box of a boot of the operator and help keep the multifunctional hammer 100 stable during pulling of a stake 50. For example, boots with steel toes can tolerate over 2,000 pounds of compression. In austere situations, the boot can serve as a stable fulcrum in less than ideal ground conditions (e.g., muddy or soggy ground) where the face end 118 of the multifunctional hammer 100 may sink into the ground during operation thereby reducing the resultant extraction force. Since this configuration moves the fulcrum closer to the face end 118 of the multifunctional hammer 100 the resulting extraction force vector is more vertical to the ground.

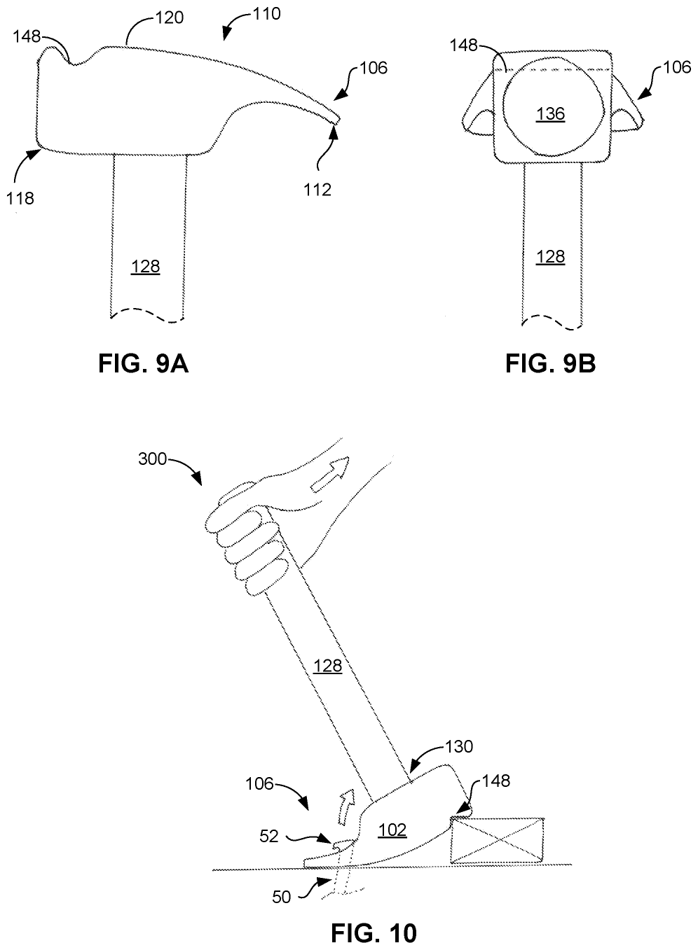

Similarly, FIGS. 9A and 9B illustrate a side and top view of another example of a multifunctional hammer 100 with a linear indentation 148 near the face end 118 and along the top surface 120 of the main body 110. In some examples, linear indentation 148 can be positioned along the top surface 120 in the impact portion 104 of the main body. In some examples, linear indentation 148 can be positioned between the face end 118 and aperture 126 or the handle 128. The linear indentation 148 being substantially parallel to the face end 118 and configured to receive as least a portion of a block to act as a fulcrum for stake extraction. The linear indentation can be formed as a rounded indentation. The linear indentation can be a feature of the multifunctional hammer 100 shown in any of the embodiments disclosed herein and/or combined with the concave indentation 146 shown in FIGS. 7A, 7B, and 8.

As shown in FIG. 10, the linear indentation 148 may partially match the edge of a block of material such as wood, metal, or composite material. In less than ideal ground conditions (e.g., muddy or soggy ground) where the face end 118 of the multifunctional hammer 100 may sink into the ground during operation thereby reducing the resultant extraction force, the block can serve as a stable fulcrum and displace the compression load long the block. The linear indentation 148 can support placement of the block and help hold the block in place as the operator pulls on the hammer handle 128. Since this configuration moves the fulcrum closer to the face end 118 of the multifunctional hammer 100 the resulting extraction force vector is more vertical to the ground. In some examples, the multifunctional hammer 100 can have both the concave indentation 146 and the linear indentation 148.

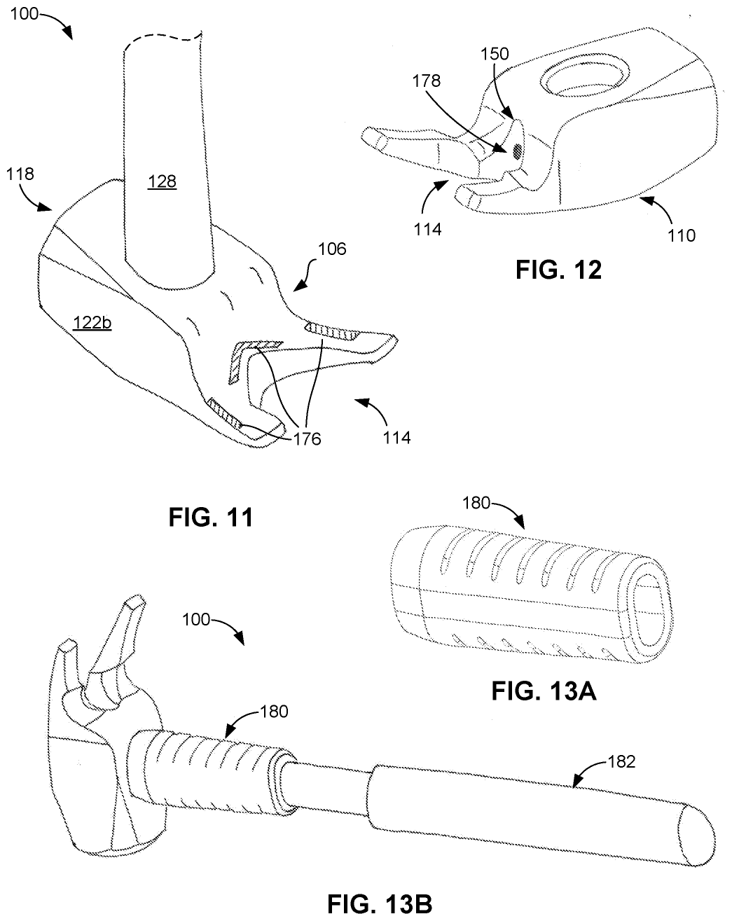

FIG. 11 shows an example of a multifunctional hammer 100 having one or more markers 176 on the extraction bottom surface 144. The one or more markers can be configured to facilitate positioning of the opening of the extraction claw portion with respect to the stake to be extracted. Similarly, one or more markers configured to facilitate positioning of the hammer face for hammering a stake. A marker material can be added to the select surfaces of the multifunctional hammer 100 to serve as a visual locator as the operator positions the extraction claw portion 106 under the stake protrusions or hammers a stake into the ground. The marker material can be in the visible and/or non-visible light spectrum. In an example of the latter, in low light or no-light conditions, if the operator wears night vision goggles they would be better able to see the position of the claw relative to the stake or more safely hammer the stake into the ground. Although the markers are illustrated on multifunctional hammer 100, the markers can be relied on for any of the embodiments described herein.

FIG. 12 shows an example of a multifunctional hammer 100 having one or more magnets 178 positioned on the body 110 of the hammer head 102 and/or within the seat 150 of the forked claw 106. In this embodiment a magnet 178 can be included near the base of the claw to further increase its hold to steel stake and other ferromagnetic stakes. Steel stakes can vary in diameter from about 0.25 to about 0.75 inches, but can also be greater than 0.75 inches. The magnet helps to constrain the stake at the narrow portion of the claw and helps prevent the stake from rocking out of the claw after the operator has extracted it from the ground.

As shown in FIG. 13A and 13B, multifunctional hammer 100 can also include a combined overstrike protector and handle grip 180. The combined overstrike protector and handle grip 180 can be positioned on the handle 128 of the multifunction hammer 100 near the proximal end, abutting the base of the head 102. The combined overstrike protector and handle grip 180 can help prevent the handle 128 from being damaged when the operator misses the object intended to strike. The combined overstrike protector and handle grip 180 can also be used as a proximal handle grip to hold the handle 128 closer to the head 102 for precision striking. For example, this alternate grip can be helpful when first driving the stake in the ground. Once a stake is partially driven into the ground, the operator can grip the distal portion of the handle 128 to create more energy with each strike. As shown in FIG. 13B, a distal handle grip 182 can also be provided for the distal portion of the handle 128. The combined overstrike protector and handle grip 180 and/or distal handle grip 182 can be made from a polymer, rubber, or any material that has solvent resistance. Solvent test fluids include J1703 brake fluid, gasoline, ethylene glycol, ethyl alcohol, and the like. The material can be tested in full immersion in the test fluid, lasting up to 20 minutes. Following the test, the material for the combined overstrike protector and handle grip 180 or distal handle grip 182 should not show swelling or surface cracks (section 6.4.1 in the ASME B107.400-2018 Striking Tool standards).

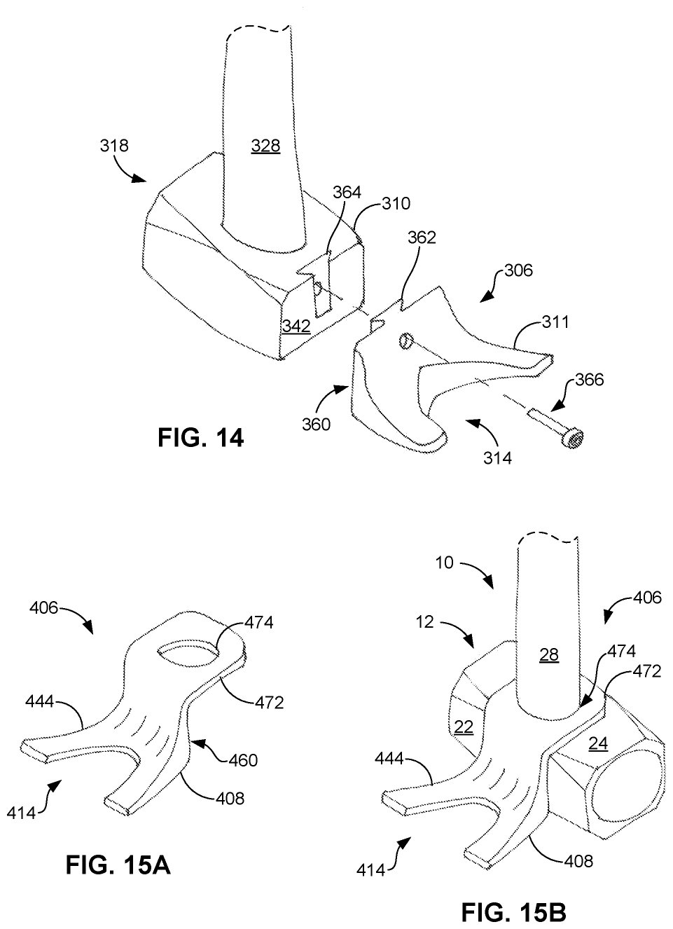

Shown in FIG. 14 is an example of the multifunctional hammer 300 having the extraction claw portion 306 detachably attached to the main body 310. The extraction claw portion 306 can be separated from the main body 310 to quickly replace the extraction claw portion 306 selected from other extraction claw portion 306 having a different claw opening 314 to optimally hook under stakes with different cross-sectional shapes. For example, the extraction claw portion 306 can have a base surface 360 opposite the forked tip end 312. The extraction claw portion 306 can have at least one keyed protrusion 362 extending from the base surface 360. The main body 310 can have at least one keyed slot 364 on the back surface 342 configured to receive the keyed protrusion 362 of the extraction claw portion 306. As can be understood, other means of attachment can be used to secure the separate extraction claw portion 306 to the main body 310. For example, the extraction claw portion 306 can have at least one keyed slot 64 formed in the base surface 360. The main body 310 can have at least one keyed protrusion 362 configured to slide into the keyed slot 364 of the extraction claw portion 306. Further, one or more fasteners can be used to secure the extraction claw portion 306 separately or in addition to the means of attachment.

FIGS. 15A and 15B show an example of a detachable extraction claw portion 406 which can be used to adapt to existing equipment or to quickly replace the claw to optimally hook under stakes with different cross-sectional shapes. An extraction claw portion 406 can include a curved body 408 having the same configuration and dimensions as extraction claw portion 106 or 206 with the curved body 408 having a forked tip end 412 formed by an opening 414. The opening 414 of the curved body 408 being substantially symmetrical having first width W1 at the forked tip end 412 tapering inwardly to opposed edges 416 having a second width W2, the curved body having an extension portion 472 opposite the forked tip end 412. The curved body 408 extending to the extension portion 472 with a bend, the extension portion 472 being substantially perpendicular to a base surface 460 of the curved body 408. The claw extension portion 406 comprising a collar aperture 474.

Similar, to the extraction claw portion 306 of FIG. 14, the extraction claw portion 406 can have a base surface 460 opposite the forked tip end 412. An extension 472 can be extend from the base surface 460 and include a collar aperture 474 configured to receive a handle. For example, the extraction claw portion 406 can receive handle 328 of the multifunctional hammer 300 of FIG. 14, positioned such that the base surface 460 abuts the back surface 342 of the main body 310 (not shown). In another example, the extension portion 406 can be used with a 3 lb. standard hammer 10, or other similar tool. As shown in FIG. 15B, the extension portion 406 can be attached at the handle 28 of standard hammer 10 such that the collar aperture 474 surrounds the handle 28, the extension 472 abuts the bottom surface 24 of the hammer 10, and the base surface 460 of the extraction claw portion 406 abuts the cheek surface 22. In another example, the detachable extraction claw portion 406 can be configured to abut the striking surface 36 of hammer 10.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

1. A head for a multifunctional hammer comprising an impact portion, an extraction portion, and a central portion therebetween, the impact portion and the central portion forming a main body of the head, the extraction portion flaring outward from the main body and tapering in thickness and branching with two claws from a base to a forked tip end forming an opening, the impact portion of the head having a face end opposite the forked tip end, the head having a top surface extending from the face end to the forked tip end, the main body having two cheek surfaces extending downward from the top surface to a bottom surface, wherein the opening of the extraction portion is configured to receive a stake head, the opening of the extraction portion being substantially symmetrical having first width at the forked tip end tapering inwardly to opposed edges having a second width and forming a seat at a base of the two claws.

2. The head of claim 1, wherein the opening of the extraction portion further comprises a contoured section extending inwardly from the opposed edges.

3. The head of claim 1, wherein the extraction portion further comprises an extraction bottom surface extending from a back surface of the main body to the forked tip end, the bottom surface configured to facilitate extraction of a stake.

4. The head of claim 1, wherein the extraction portion further comprises a stake protrusion seat in the extraction bottom surface of the extraction portion, the stake protrusion seat formed by a rounded indentation across both claws and the width of the extraction portion near the back surface of the main body.

5. The head of claim 1, wherein the contoured section comprises a third width and a half pipe cavity within the opening, where the opening tapers inward from the second width to the third width and the half pipe cavity forms the seat in the opening of the claw.

6. The head of claim 5, wherein the extraction portion further comprises a tapered collar in the extraction bottom surface of the extraction claw portion surrounding the half pipe cavity and extending to each of the two claws within the stake protrusion seat.

7. The head of claim 1, wherein the top surface has a curved shape extending from the main body to the forked tip end, the top surface configured to facilitate extraction of a stake.

8. The head of claim 1, further comprises an aperture through the central portion of the main body, the aperture extending from top surface to the bottom surface, the aperture configured to receive a handle to be secured to the head.

9. The head of claim 1, wherein the head weighs between about 2 and about 8 pounds.

10. The head of claim 1, wherein the top surface of the main body further comprises a concave indentation extending from the face end and having a curved perimeter, the concave indentation configured to receive a boot tip to act as a fulcrum for stake extraction.

11. The head of claim 1, wherein the top surface of the main body further comprises a linear indentation between the face end and the central portion, the linear indentation being substantially parallel to the face end and configured to receive as least a portion of a block to act as a fulcrum for stake extraction.

12. The head of claim 1, further comprising one or more markers on the extraction bottom surface configured to facilitate positioning of the opening of the extraction portion with respect to the stake to be extracted.

13. The head of claim 1, further comprising one or more markers configured to facilitate positioning of the hammer face for hammering a stake.

14. The head of claim 12, wherein the one or more markers are applied using a marker material detectable in visible light, non-visible light, or both.

15. The head of claim 1, wherein the extraction portion is detachably attached to the main body.

16. The head of claim 15, wherein the extraction portion further comprises a base surface and a keyed protrusion extending from the base surface and the main body has a keyed groove configured to receive the keyed protrusion of the extraction portion.

17. The head of claim 16, wherein the extraction portion is secured to the main body via one or more fasteners.

18. A multifunctional hammer comprising the head of claim 1 and a handle having a proximal end and a distal end, the handle attached to the head.

19. The multifunctional hammer of claim 18, wherein the main body of the head comprises an aperture through the central portion of the head, the aperture extending from top surface to the bottom surface, and wherein the proximal end of the handle is secured in the aperture of the head.

20. The multifunctional hammer of claim 1, wherein the head and the handle are fabricated in one piece.

21. The multifunctional hammer of claim 18, wherein the handle has a length of about 12 to about 36 inches.

22. The multifunctional hammer of claim 18, further comprising a combined overstrike protector and handle grip attached to the handle at a portion abutting the base of the head.
